(19) United States
(12) Patent Application Publication
(10) Pub. No.: US 2013/0232285 A1
(43) Pub. Date: Sep. 5, 2013

(54) CONTROL METHOD OF FLOW CONTROL SCHEME AND CONTROL MODULE THEREOF

(71) Applicants: Wei-Yun Chang, New Taipei City (TW); Shu-Tzu Wang, New Taipei City (TW)

(72) Inventors: Wei-Yun Chang, New Taipei City (TW); Shu-Tzu Wang, New Taipei City (TW)

(73) Assignee: ASMedia Technology Inc., New Taipei City (TW)

(21) Appl. No.: 13/778,129

(22) Filed: Feb. 27, 2013

(30) Foreign Application Priority Data
Mar. 5, 2012 (TW) 101107304

(51) Int. Cl. H04L 12/56

(52) U.S. Cl. CPC H04L 47/10
USPC 710/29

(57) ABSTRACT

A control method of flow control scheme and a control module thereof are provided. The provided control method includes setting a value of the transaction packets and outputting data to an external device according to the value of the transaction packets. When a not-ready transaction packet is received, the value of the transaction packets is reduced and the data is transmitted according to the value of the transaction packets.

### CROSS-REFERENCE TO RELATED APPLICATION

This application claims the priority benefit of Taiwan application serial no. 101107304, filed on Mar. 5, 2012. The entirety of the above-mentioned patent application is hereby incorporated via reference herein and made a part of this specification.

### BACKGROUND OF THE INVENTION

1. Field of the Invention

The disclosure relates to a control method of flow control scheme and, more particularly, to a control method of flow control scheme applied to a host and an external device.

2. Description of the Related Art

Due to convenience, hot-plug, and plug-and-play (which does not need additional drivers), a universal serial bus (USB) becomes a necessary interface for peripheral devices. The USB bus is taken as a basic interface for most electronic devices such as a personal computer and handheld devices. Most peripheral devices of a computer such as a mouse, a keyboard, an external hard disk, a printer, a flash drive, a webcam, and a card reader are connected with the computer via the USB interface.

The data transmission of the second generation USB (USB 2.0) is in a one-way channel and half-duplex mode. The data transmission of the third generation USB is in a two-way channel and full-duplex mode, and thus data can be transferred to the destination more efficiently. The speed of a physical layer of the second generation USB is 480 Mbit/s, and the speed of that of the third-generation USB (USB 3.0) is increased to 5 Gbit/s, which is ten times faster. The second generation USB uses the method of polling, but the third generation USB uses the not-ready (NRDY) mechanism and the endpoint ready (ERDY) mechanism of proactive notification.

### BRIEF SUMMARY OF THE INVENTION

A control module of flow control scheme applied to a host is provided. The control module includes a first communication port, a controller, and a processing unit. The first communication port is coupled to external devices. The controller is coupled to the first communication port. The processing unit is coupled to the controller and a value of the transaction packets is set to make the controller transmit the data according to the value of the transaction packets. When the first communication port receives a NRDY transaction packet from external devices, the processing unit reduces the value of the transaction packets to make the controller transmit transmission data according to the reduced value of the transaction packets.

In one embodiment, in setting the value of the transaction packets, the process unit sets a maximum value of the transaction packets of the controller can transfer as the value of the transaction packets.

In one embodiment, the processing unit reduces the value of the transaction packets, and the controller transfers next batch of the transmission data according to the adjusted value of the transaction packets.

In one embodiment, if the first communication port does not receive the NRDY transaction packet after a batch of transmission data transmitting is completed, the processing unit maintains or increases the value of the transaction packets. So the controller transmits next batch of the transmission data according to the value of the transaction packets.

In one embodiment, the controller is an output controller.

In one embodiment, the output controller includes a first direct memory storage unit. The first direct memory storage unit is used to capture a data segment from the host for transmission.

In one embodiment, the controller is an input controller.

In one embodiment, the input controller includes a second direct memory storage unit. The second direct memory storage unit is used to transmit the input data to the host.

In one embodiment, the first communication port supports a third generation USB standard.

Moreover, a control method of flow control scheme applied to the host is provided. The control method includes: setting a value of the transaction packets; transmitting transmission data to the external devices according to the value of the transaction packets; reducing the value of the transaction packets and transmitting transmission data according to the reduced value of the transaction packets when a NRDY transaction packet is received.

In one embodiment, the procedure of setting value of the transaction packets includes: setting a maximum values of transmitting transaction packets as the value of the transaction packets.

In one embodiment, the value of the transaction packets is reduced. When next batch of the transmission data is transmitted, the data is transmitted according to the adjusted value of the transaction packets.

In one embodiment, the control method includes: if the NRDY transaction packet is not received when the transmission of a batch of data is completed, the value of the transaction packets is maintained or reduced. And the data is transmitted according to the maintained or reduced value of the transaction packets when the next schedule is transmitted.

In one embodiment, the NRDY transaction packet in the control method is sent out via the external devices.

In one embodiment, the external device in the control method is a third generation USB.

Based on above, the host can transmit data to the external devices at a better speed by setting the best value of the transaction packets of flow control scheme. The transmission delay from the host to the external devices is effectively reduced, so that the delay time is reduced and the transmission efficiency is enhanced.

### BRIEF DESCRIPTION OF THE DRAWINGS

FIG. 1 is a schematic diagram showing the transmission delay in one embodiment.

FIG. 2 is a schematic diagram showing capturing data from a storage device via a method of Device Context Base Address Array in one embodiment.

FIG. 3 is a schematic diagram showing a host and an external device in one embodiment.

FIG. 4 is a flowchart showing an control method of flow control scheme in another embodiment.

FIG. 5A and FIG. 5B are schematic diagrams showing the transmission flow according to an embodiment of the disclosure.

FIG. 6 is a schematic diagram showing the transmission delay in one embodiment.

### DETAILED DESCRIPTION OF THE EMBODIMENTS

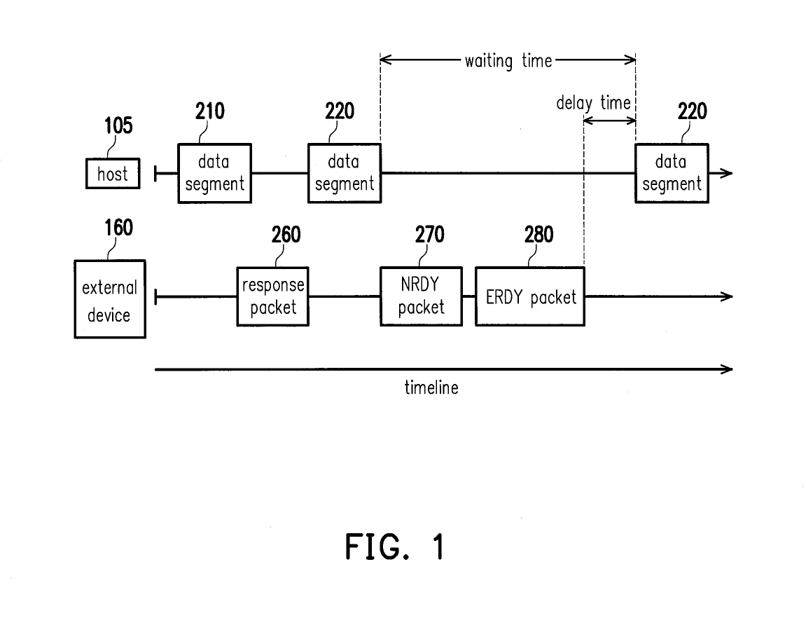

FIG. 1 is a schematic diagram showing the transmission delay situation in one embodiment. Referring to FIG. 1, the data transmission between a host 105 and an external device 160 is shown on the timeline. In a plurality of data segments, the amount of data transmission of each data segment conforms to the third generation USB specification. First, the host 105 sends out the data segment 210. When the external device 160 receives the data segment 210, it replies a response transaction packet 260 to the host 105. The response transaction packet 260 is usually a general acknowledgement in the communication field.

After the host 105 receives the response transaction packet 260 from the external USB devices 160, the host 105 transmits transmission data segment 220 to the external USB device 160. At the time, if the external USB device 160 cannot receive data segment temporarily, the external USB device 160 sends a NRDY transaction packet to the host 105 to inform the host 105 that the data segment cannot be successfully received at the time. When the external device 160 can receive data segments again, an ERDY transaction packet 280 is sent to the host 105 to inform the host 105 that it can receive the data segment again. The host 105 resends the data segment 220 to the external device 160. The NRDY transaction packet may conform to a general NRDY mechanism of the third generation USB, and the ERDY transaction packet may conform to a general ERDY mechanism of the third generation USB.

After sending the data segment 220 the first time, the host 105 enters into a waiting time to wait the acknowledgement of the external device 160. If the response of the external device 160 is a NRDY transaction packet 270, the host 105 continues waiting. When the host 105 receives the ERDY transaction packet 280, according to the general mechanism of data transmission between the host 105 and the external device 160, the host 105 needs to re-search and capture data from the memory and retransmit the data segment 220 via a method of Device Context Base Address Array (DCBAA).

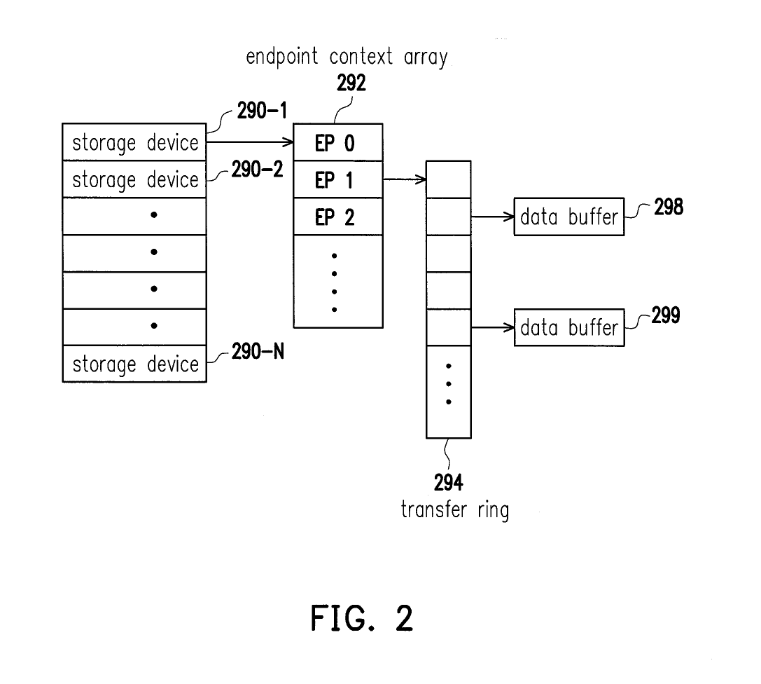

The above DCBAA method is shown in FIG. 2. First, finding the storage device to transmit the data segment (290-1˜290-N). Then, finding the corresponding endpoint context array 292, and then capturing data from a data buffer 298 or 299 via a transfer ring 294. That is, when the host 105 stops transmitting transmission data after receiving a not-ready transaction packet 270, the above steps should be repeated to make the host 105 resume transmission data transmission again. Thus, a delay time is generated. Consequently, the waiting time of the host 105 further includes a delay time for re-capturing data, which costs much more time and results in a delay in transmitting transmission data segment.

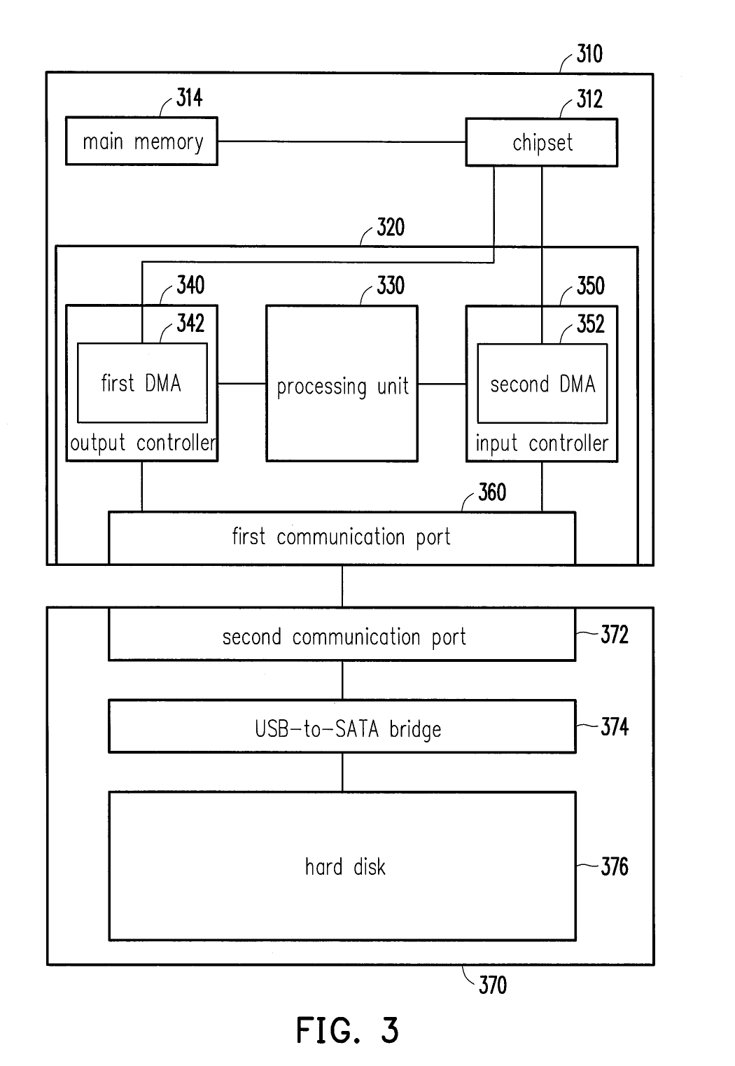

FIG. 3 is a schematic diagram showing a host and an external device in one embodiment. Referring to FIG. 3, the host 310 is coupled to the external device 370. The host 310 includes a control module 320 of flow control scheme, a chipset 312 and a main memory 314. The chipset 312 is coupled between the main memory 314 and the control module 320. The control module 320 includes a processing unit 330, a controller and a first communication port 360, and the controller includes an output controller 340 and an input controller 350. The processing unit 330 is coupled to the output controller 340. The first communication port 360 is coupled to the external device 370, and the communication port 360 supports the third generation USB specification. The output controller 340 and the input controller 350 can be coupled to the output endpoint of the external device 370 via the first communication port 360.

The output controller 340 may include a first direct memory access unit (DMA) 342. While outputting data externally, the first DMA 342 of the output controller 340 is used to transmit data to the external device 370. The input controller 350 includes a second DMA 352. While inputting external data, the second DMA 352 of the input controller 350 is used to transmit the incoming data to the main memory 314 of the host 310.

The host 310 may be a desktop computer, a notebook computer, a personal digital assistant (PDA), a PDA phone or others, which is not limited herein.

The external device 370 may include a second communication port 372, a USB-to-SATA bridge 374 and a hard drive 376. The USB-to-SATA bridge 374 is coupled between the second communication port 372 and the hard drive 376. The second communication port 372 supports the third generation USB specification. The external device 370 also may be a printer, a flash drive, a webcam, a card reader or others besides an external hard drive, which is not limited herein.

The output controller 340 is taken as an example herein. The processing unit 330 controls the output controller 340 and sets a value of the transaction packets at the initial stage. For example, the processing unit 330 may set the maximum values of the transaction packet which the output controller 340 can transmit as the value of the transaction packets. According to the third generation USB specification, if the maximum value of data is 16K bytes, the data is divided into 16 transaction packets for transmission, and each of the transaction packets is 1K byte. The value of the transaction packets can be used to set and adjust service opportunity transaction packet count (SOPC), and thus the value of the transaction packets is adjustable but not constant as conventional technology. The main memory 314 can store at least a data segment. The first DMA 342 captures corresponding data segment from the host 310 to transmit to the external device 370. While transmitting transmission data, the output controller 340 outputs data according to maximum values of the transaction packets. If the first communication port 360 receives a NRDY transaction packet from the external device 370, the processing unit 330 reduces the setting value of the transaction packets to make the controller 340 transmit transmission data according to the reduced value of the transaction packets.

For example, the processing unit 330 can reduce the value of the transaction packets. In transmitting next batch of the transmission data, the processing unit 330 makes the controller 340 transmit data according to the adjusted values of the transaction packet.

The external device 370 may cannot process the maximum values of data at a time, and it needs some waiting time at every data transmission according to conventional technology. However, according to the method for adjusting value of the transaction packets in the above embodiment of the disclosure, the next batch of the transmission data can be transmitted according to the reduced value of the transaction packets. As a result, when the host 310 transmits data to the external device 370 next time, the waiting time is shortened. The control module 320 can adjust the value of the transaction packets coordinate with the transmission capacity of the external device 370, and thus the NRDY transaction packet would not be received in transmission data transmission. Consequently, the control module 320 of flow control scheme can avoid that the external device 370 cannot receive.

On the other hand, when the transmission of a batch of data is completed, and the first communication port 360 does not receive the NRDY transaction packet, the processing unit 330 can maintain or increases the value of the transaction packets. Then, the output controller 340 transmits transmission data according to the maintained or increased transaction packet. Consequently, the control module 320 of flow control scheme has higher transmission efficiency compared to that of conventional technology.

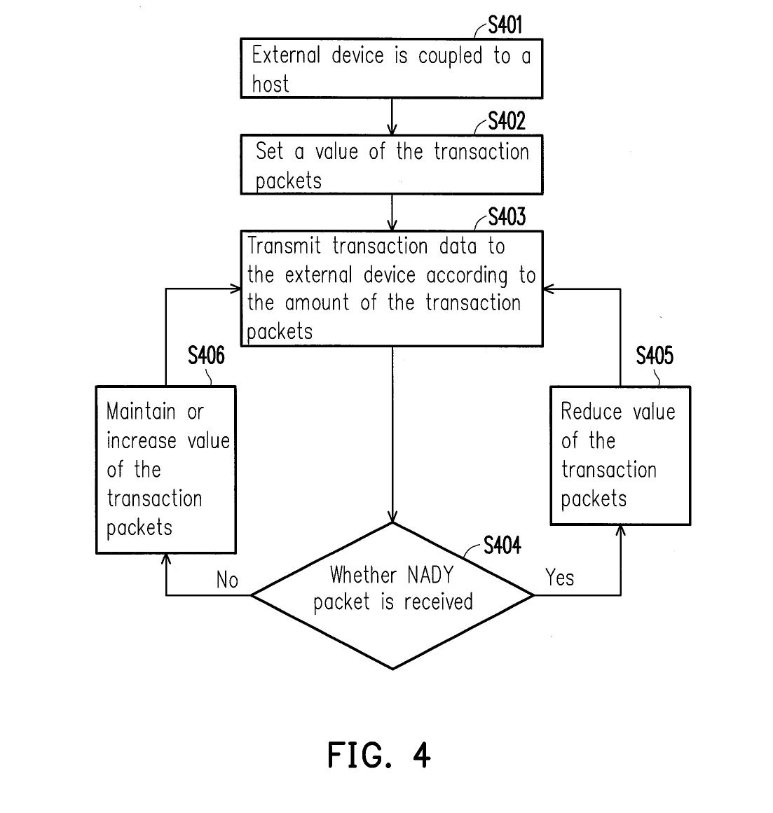

FIG. 4 is a flowchart showing a control method of flow control scheme in another embodiment to further illustrate the detailed operation process of the control module. Referring to FIG. 3 and FIG. 4.

In step S401, the external device 370 is coupled to the host 310. When the processing unit 330 of the host 310 recognizes the control endpoint, the input endpoint, and the output endpoint of the external device 370, parameters of each endpoint are set.

In step S402, the control module 320 set a value of the transaction packets at the initial stage. For example, the value of the transaction packets may be the maximum values of the transaction packets transmitted by the output controller 340. The method of setting initial value of the transaction packets is not limited herein.

In step S403, the control module 320 transmits data to the external device 370 according to the value of the transaction packets.

In step S404, the processing unit 330 of the control module 320 determines whether the NRDY transaction packet is received. If the processing unit 330 receives the NRDY transaction packet as shown in step S405, the value of the transaction packets is reduced and next batch of the transmission data is transmitted according to the reduced value of the transaction packets. The minimum value of the transaction packets may be limited at 8K bytes, which is not limited herein. Then, back to step S403, it takes the adjusted value of the transaction packets as the setting value to transmit next batch of the transmission data.

In step S404, if the processing unit 330 does not receive the NRDY transaction packet, as shown in step S406, the value of the transaction packets is maintained or increased, and next batch of transmission data is transmitted according to the maintained or increased value of the transaction packets. The maximum value of the transaction packets may be limited at 16K bytes. Then, back to step S403, it takes the adjusted value of the transaction packets as the setting value to transmit next batch of transmission data.

For example, in transmitting schedule, if the NRDY transaction packet is received when the value of the transaction packets is 12K bytes, the value of the transaction packets is reduced from 12K bytes to 10K bytes. If the NRDY transaction packet is not received when the value of the transaction packets is 10K bytes, 1K bytes may be plus to the value of the transaction packets and next batch of transmission data is transmitted at the value of the transaction packets of 11K bytes, which is not limited herein.

As a result, the control method of flow control scheme can avoid the problem that the external device 370 cannot receive, and the transmission efficiency is higher.

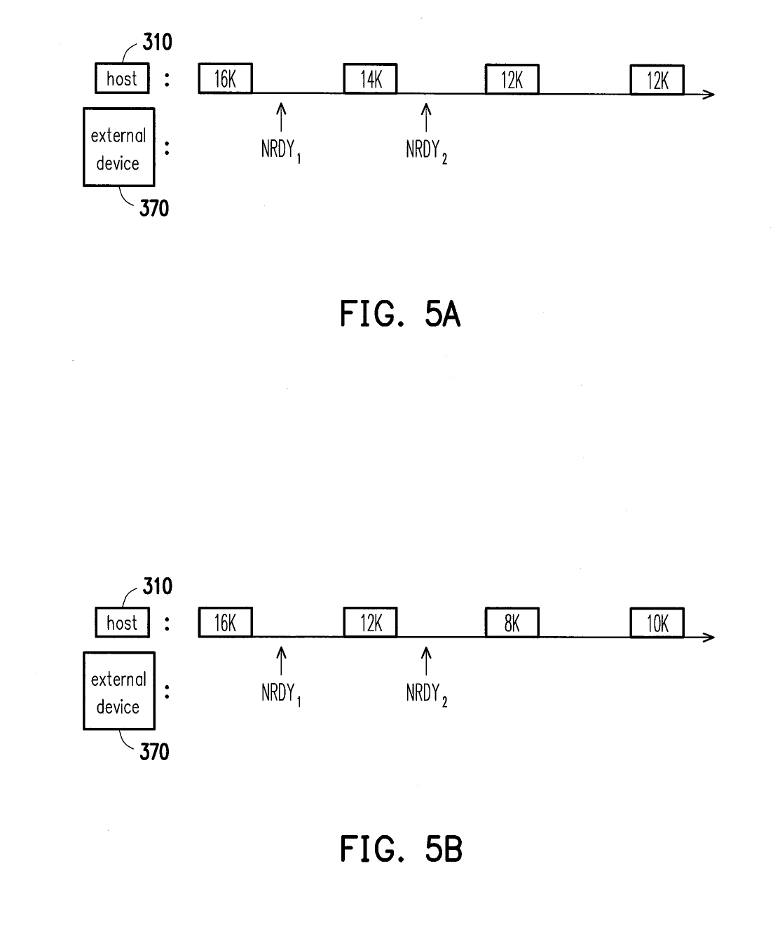

FIG. 5A and FIG. 5B are schematic diagrams showing the transmission flow according to an embodiment of the disclosure in the view of decreasing value of the transaction packets or/and increasing value of the transaction packets.

Referring to FIG. 5A, the host 310 outputs the value of the transaction packets of 16K bytes in the initial stage, and the external device 370 sends a NRDY transaction packet NRDY1. Then, the host 310 changes to output a value of the transaction packets to 14K bytes, and the external device 370 sends a NRDY transaction packet NRDY2 again. The host 310 changes to output the value of the transaction packets of 12K bytes, and the external device 370 do not send a NRDY transaction packet. As a result, the host 310 continues the flow control scheme at the value of the transaction packets of 12K bytes, which is not limited herein.

Referring to FIG. 5B, the host 310 outputs the transaction packets of 16K bytes in the initial stage, and the external device 370 sends a NRDY1 transaction packet. The host 310 makes the value of the transaction packets reduce 4K bytes to 12K bytes, and the external device 370 sends a NRDY2 transaction packet again. The host 310 further makes the value of the transaction packets reduce 4K bytes again to 8K bytes, and the external device 370 does not send a NRDY transaction packet again. Then, the host 310 makes the value of the transaction packets increase 2K bytes to 10K bytes, and the external device 370 does not send a NRDY transaction packet so that the host 310 can use the value of the transaction packets of 10K bytes to have flow control scheme, which is not limited herein.

Furthermore, the maximum value of the transaction packets also may be set to 16K bytes while the minimize value of the transaction packets is set to 8K bytes. In the flow control scheme of decreasing or increasing value of the transaction packets, the best transmission speed can be found. FIG. 5A and FIG. 5B are embodiments of the disclosure, the adjustment range of decreasing or increasing the value of the transaction packets is not limited herein.

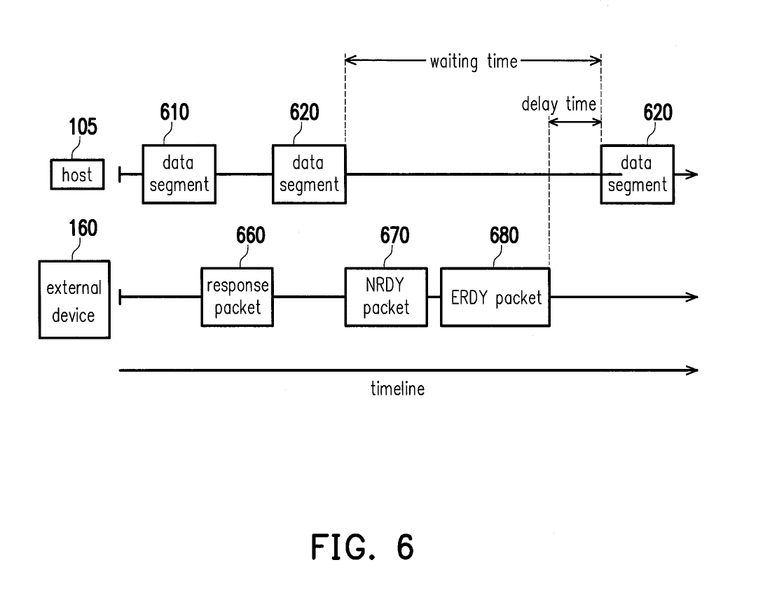

FIG. 6 is a schematic diagram showing a transmission delay in one embodiment. When the input controller 350 controls the external device 370 to transmit data, the host 105 sends a request 610 to the external device 160, and the external device 160 replies a data segment 660 to the host 105, and then the host 105 transmits a next request 620 to the external device 160. If the external device 160 cannot transmit data segment to the host 105 at the time, the external device 160 sends a NRDY transaction packet 670 to the host 105 to inform the host 105 that it cannot receive data segments normally. When the external device 160 can restore to transmit data segments to the host 105 again, it sends an ERDY transaction packet 680 to the host 105 to inform the host 105 that it can receive data segments again, and then the host 105 can send the request 620 to the external device 160 again. The following control method of the flow control scheme of the input controller 350 is same to that of the output controller 340, which is omitted herein.

In sum, the host can transmit data to the external device at higher speed by setting better transmission value of the transaction packets of flow control scheme. The problem of delay of transmission between the host and the external device is reduced, and thus the delay time is reduced and the efficiency of transmitting is enhanced.

Although the disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A control module of flow control scheme, adapted to a host, comprising:
a first communication port coupled to an external device;
a controller coupled to the first communication port; and
a process unit coupled to the controller and setting a value of the transaction packets to make the controller transmit transmission data according to the value of the transaction packets, and wherein if the first communication port receives a not-ready (NRDY) transaction packet from the external device, the process unit reduces the value of the transaction packets to make the controller transmit the transmission data according to the reduced value of the transaction packets.

2. The control module of flow control scheme according to claim 1, wherein the process unit sets a maximum values of the transaction packets which the controller can transmit transmission data according to the maximum value of the transaction packets.

3. The control module of flow control scheme according to claim 1, wherein the process unit reduces the value of the transaction packets, and the controller transmits next batch of transmission data according to the adjusted value of the transaction packets.

4. The control module of flow control scheme according to claim 1, wherein if the first communication port does not receive the NRDY transaction packet after a batch of transmission data transmitting is completed, the process unit maintains or increases the value of the transaction packets and the controller transmits next batch of transmission data according to the maintained or increased value of the transaction packets.

5. The control module of flow control scheme according to claim 1, wherein, the controller is an output controller.

6. The control module of flow control scheme according to claim 5, wherein the output controller includes:
a first direct memory access unit capturing a data segment from the host for transmission.

7. The control module of flow control scheme according to claim 1, wherein the controller is an input controller.

8. The control module of flow control scheme according to claim 7, wherein the input controller includes:
a direct memory access unit transferring the data to the host.

9. The control module of flow control scheme according to claim 1, wherein the first communication port supports a third universal serial bus (USB) specification.

10. A control method of flow control scheme, adapted to a host, comprising:
setting a value of the transaction packets;
transmitting transmission data to an external device according to the value of the transaction packets; and
reducing the value of the transaction packets and transmitting the transmission data according to the reduced value of the transaction packets when a NRDY transaction packet is received.

11. The control method of flow control scheme applied to a host according to claim 10, wherein the process of setting the value of the transaction packets comprises:
setting a maximum value of the transaction packets as the value of the transaction packets.

12. The control method of flow control scheme according to claim 10, wherein the value of the transaction packets is reduced, and next batch of transmission data is transmitted according the adjusted value of the transaction packets.

13. The control method of flow control scheme according to claim 10, further comprising: wherein if the NRDY transaction packet is not received after a batch of transmission data transmitting is completed, the value of the transaction packets is maintained or increased, and next batch of transmission data is transmitted according to the maintained or increased value of the transaction packets.

14. The control method of flow control scheme according to claim 10, wherein the NRDY transaction packet is sent out by the external device.

15. The control method of flow control scheme according to claim 10, wherein the external device is a third generation USB device.
